(19) United States
(12) Patent Application Publication
(10) Pub. No.: US 2019/0009692 A1
(43) Pub. Date: Jan. 10, 2019

(54) Operating Device for an Actuator Adjustable Motor Vehicle Seat

(71) Applicant: Leopold Kostal GmbH & Co. KG, Luedenscheid (DE)

(72) Inventors: Michael Bleckmann, Schwerte-Ergste (DE); Philipp Ciolek, Sprockhoevel (DE); Andre Fehling, Dortmund (DE); Alexander Kaul, Sprockhoevel (DE)

(73) Assignee: Leopold Kostal GmbH & Co. KG, Luedenscheid (DE)

(21) Appl. No.: 16/026,496

(22) Filed: Jul. 3, 2018

(30) Foreign Application Priority Data
Jul. 5, 2017 (DE) 10 2017 006 319.2

(51) Int. Cl. B60N 2/02

(52) U.S. Cl. CPC B60N 2/0228; B60N 2/0244

(57) ABSTRACT

An operating device for an actuator-adjustable motor vehicle seat includes a control element and multiple force sensors. The control element has a contour which simulates the outline shape of the motor vehicle seat. Pressing actuations directed to various locations on the contour of the control element trigger different adjustment movements of the vehicle seat. The pressing actuations are detected by the force sensors which can measure horizontal and vertical forces. The actuation position and the actuation direction of a finger on the control element may be detected from the reaction forces of the force sensors. The force sensors are designed as three force sensors that measure in one dimension; two of the force sensors are situated in parallel to one another; and a third force sensor is situated perpendicularly with respect to the other two force sensors.

### CROSS-REFERENCE TO RELATED APPLICATIONS

This application claims priority to DE 10 2017 006 319.2, filed Jul. 5, 2017; the disclosure of which is hereby incorporated in its entirety by reference herein.

### TECHNICAL FIELD

The present invention relates to an operating device for an actuator-adjustable motor vehicle seat, the operating device having a control element and multiple force sensors, the control element having a contour which simulates the outline shape of the vehicle seat and the force sensors can measure horizontal and vertical forces, wherein pressing actuations directed to various locations on the contour of the control element for triggering different adjustment movements of the vehicle seat are detected by the force sensors and the actuation position and the actuation direction of a finger on the control element are detectable from the reaction forces of the force sensors.

### BACKGROUND

An operating device for an adjustable motor vehicle seat in which the operating device has a control element which simulate the contour of the vehicle seat is known in many designs. A vehicle seat is made of up of several sections such as a seat cushion, a backrest, and a head restraint. The sections of the vehicle seat, such as the seat cushion, the backrest, and the head restraint, are designed to be adjustable relative to one another.

To allow a motorized adjustment of the sections of a vehicle seat, a seat adjustment switch must provide an appropriate number of switching functions. For these switching functions to be intuitively operable, the seat adjustment switch has an outer contour which represents the sections of the vehicle seat. The outer contour may be acted on by a force at appropriate locations to trigger a switching function associated with the actuation point. Known seat adjustment switches have several push switches or slide switches for providing these switching functions. Thus, such seat adjustment switches are mechanically relatively complex and intricate.

An operating device for operating an adjustable seat of a motor vehicle is known from DE 10 2013 016 340 A1 (corresponds to U.S. Pat. No. 9,908,438). The operating device is intended to allow simple, intuitive, and reliable control of the actuators of an adjustable vehicle seat. The use of force sensors is proposed for this purpose. One of the described designs provides force sensor devices that may respectively measure horizontal and vertical forces. Based on the reaction forces on the bearing points, the actuation position of a finger on the control element of the operating device may be computed. A distinction may be made, for example, between an intended adjustment of the seat cushion height and of the seat cushion inclination. Appropriately designed control units may also be provided for adjusting the backrest and the head restraint.

### SUMMARY

An object is to provide an operating device for an adjustable motor vehicle seat in which the operating device has a relatively less complicated sensor system.

In embodiments of the present invention, an operating device for an actuator-adjustable motor vehicle seat includes a control element and multiple force sensors. The control element has a contour which simulates the outline shape of the vehicle seat. The force sensors are designed as three force sensors. Each force sensor can measure force in one dimension. For instance, a first force sensor can measure only vertical force, a second force sensor can measure only vertical force, and a third force sensor can measure only horizontal force. Two of the force sensors are situated in parallel to one another. The third force sensor is situated perpendicularly with respect to the other two force sensors.

In carrying out at least one of the above and/or other objects, an operating device for an actuator-adjustable vehicle seat includes a control element and three force sensors. The control element has an outer contour which simulates an outline shape of a vehicle seat. The three force sensors include a first force sensor, a second force sensor, and a third force sensor. Each force sensor can measure force in only one direction. The first and third force sensors are situated in parallel with one another. The second force sensor is situated perpendicularly with respect to the first and third force sensors. The force sensors are configured to detect pressing actuations directed to various locations on the outer contour of the control element for triggering different adjustment movements of the vehicle seat and an actuation position and an actuation direction of a pressing actuation of a finger on the outer contour of the control element for triggering an adjustment movement of the vehicle seat is detectable from reaction forces of the force sensors.

An embodiment of the present invention provides an operating device for an actuator-adjustable motor vehicle seat. The operating device has a control element and a plurality of force sensors. The control element has an outer contour which simulates the outline shape of the vehicle seat. The force sensors as a group can measure horizontal and vertical forces. Pressing actuations directed to various locations on the contour of the control element trigger different adjustment movements of the vehicle seat. The force sensors detect the pressing actuations. The actuation position and the actuation direction of a finger on the control element may be detected from the reaction forces of the force sensors.

The force sensors are designed as three force sensors. Each force sensor can measure force in one direction. First and second force sensors are situated in parallel to one another. For example, the first and second force sensors can each measure vertical forces. A third force sensor is situated perpendicularly with respect to the first and second force sensors. For instance, the third force sensor can measure horizontal forces.

The approach from the above-mentioned DE 10 2013 016 340 A1 provides at least two force sensors which each measure in two dimensions. In contrast, an operating device in accordance with embodiments of the present invention employs the use of three force sensors which each measure in just one dimension. A force sensor which measures in just one dimension has a much simpler design than a force sensor which measures in two dimensions. For this reason, three force sensors which each measure in one dimension are frequently less expensive than two force sensors which each measure in two dimensions.

An operating device in accordance with embodiments of the present invention advantageously has a simple design, and in addition is manufacturable as a preassembled unit so that it may be tested for functionality before it is installed in a motor vehicle.

### BRIEF DESCRIPTION OF THE DRAWINGS

Exemplary embodiments of the present invention are explained in greater detail below with reference to the drawings, which include the following:

FIG. 1 illustrates an exploded view of an operating device for an actuator-adjustable motor vehicle seat;

FIG. 2 illustrates a schematic top view of the control element of the operating device; and

FIGS. 3, 4, 5, and 6 illustrate schematic top views depicting first, second, third, and fourth examples, respectively, of possible actuations of the control element.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

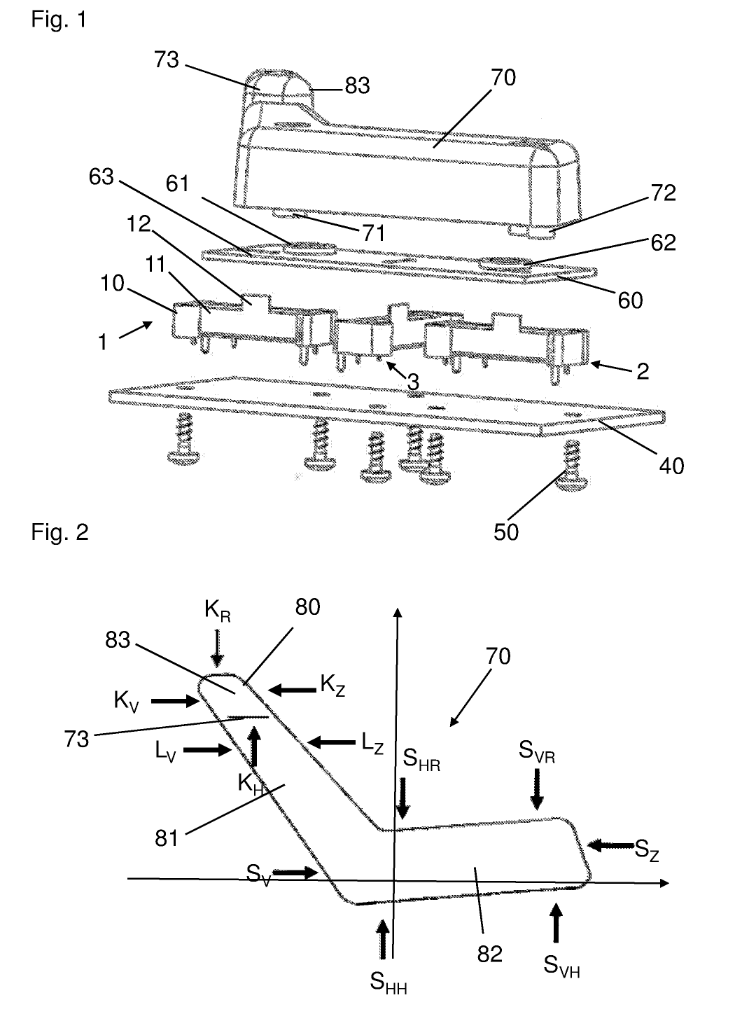

FIG. 1 illustrates an exploded view of an operating device for an actuator-adjustable motor vehicle seat. The operating device has a one-piece control element 70. Control element 70 has an outer shape or contour 80. Contour 80 simulates the lateral outline shape of the vehicle seat.

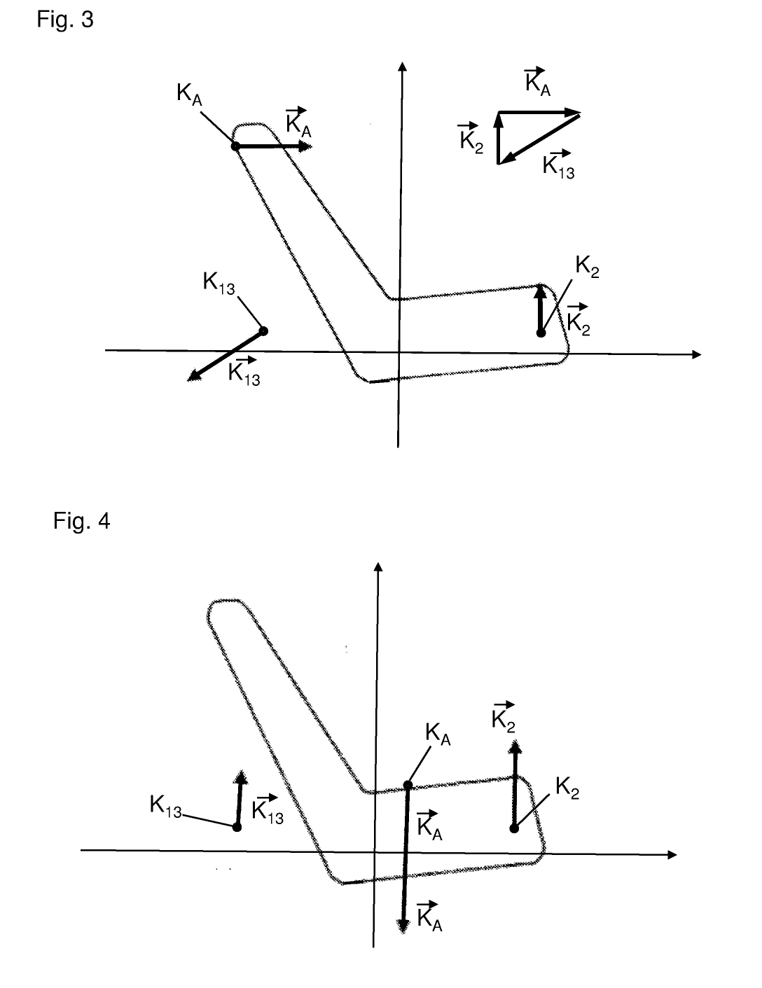

FIG. 2 illustrates a schematic view of control element 70 of the operating device. Control element 70 is schematically illustrated in FIG. 2 in a top view to clarify contour 80.

Control element 70 forms a first section 81 and a second section 82. Sections 81 and 82 are angled with respect to one another. The surfaces of sections 81 and 82 form press-actuatable actuation points for controlling the adjustment movements of multiple actuator-adjustable components of the vehicle seat.

First section 81 of control element 70 is inclined as illustrated in FIG. 2. First section 81 is for adjusting the head restraint and the seat back of the vehicle seat. Second section 82 of control element 70 is aligned approximately horizontally as illustrated in FIG. 2. Second section 82 is for adjusting the seat cushion of the vehicle seat.

A protrusion 73 is integrally formed on the upper portion of first section 81. Protrusion 73 at this location allows a head restraint section 83 of first section 81 to be pushed up to trigger the “head restraint up” function K_{H}. The actuation functions head restraint up/down K_{H}, K_{R}, head restraint forward/backward K_{V}, K_{Z}, seat back forward/backward L_{V}, L_{Z}, seat cushion front portion up/down S_{VH}, S_{VR}, seat cushion rear portion up/down S_{HH}, S_{HR}, and seat cushion forward/backward S_{V}, S_{Z} may thus be actuated via stylized contour 80 of the vehicle seat.

Thus, a total of twelve actuation functions K_{H}, K_{R}, K_{V}, K_{Z}, L_{V}, L_{Z}, S_{VH}, S_{VR}, S_{HH}, S_{HR}, S_{V}, S_{Z} that must be recognized and differentiated by a sensor system are associated with control element 70. As indicated by the arrows which depict the actuation functions, the actuation forces for the individual actuation functions act on control element 70 either in the horizontal or in the vertical direction. The actuation function that is selected is a function of the point of action on control element 70.

The operating device further includes three force sensors. The three force sensors are a first force sensor 1, a second force sensor 2, and a third force sensor 3. Force sensors 1, 2, 3 as a group can measure horizontal and vertical forces. Pressing operations on control element 70 are detected by force sensors 1, 2, 3. An electronics system controller in communication with force sensors 1, 2, 3 (not shown) determines the actuation position and actuation direction of a finger on control element 70 based on the reaction forces of force sensors 1, 2, 3. The electronics system controller uses the determined actuation position and actuation direction in controlling actuators to adjust the vehicle seat.

Force sensors 1, 2, 3 are designed as three sensors that each measure in one dimension; two of the force sensors are situated in parallel to one another; and the remaining force sensor is situated perpendicularly with respect to the other two force sensors. Force sensors 1, 2, 3 are illustrated in FIG. 1 as three components having an identical design. First and second force sensors 1 and 2 are situated in parallel to one another and are aligned with one another on a line. Third force sensor 3 is situated between first and second force sensors 1 and 2 and is oriented perpendicularly with respect to first and second force sensors 1 and 2. Due to the basically identical design of the three force sensors 1, 2, 3, only the details of first force sensor 1 have been provided with individual reference numerals.

Sensor housings 10 of force sensors 1, 2, 3 are fastened to a support plate 40 by screws 50. For all force sensors 1, 2, 3, a strip-shaped actuation element 11 is situated within the respective sensor housing 10. Strip-shaped actuation elements 11 have on their top side an integrally molded actuation bar 12. Actuation bars 12 are inserted into slotted recesses 63 in a coupling plate 60. Slotted recesses are shaped to fit actuation bars 12. Actuation elements 11 of force sensors 1, 2, 3 are thus mechanically connected to coupling plate 60.

Actuation elements 11 are supported within the respective sensor housing 10 to be slightly displaceable along the longitudinal direction and the transverse direction of the sensor housing. Actuation elements 11 are thus able to follow moderate movements of coupling plate 60 in all directions.

As sensors that measure in one dimension, force sensors 1, 2, 3 each detect a force component that acts along one line. It is assumed in the following discussion that for force sensors 1, 2, 3, force effects on actuation element 11 along the positive and the negative transverse directions of sensor housing 10 result in a detectable change in the sensor signal, while force effects along the longitudinal direction of sensor housing 10 result in no changes in the sensor signal. The internally used force sensor system may be based on any suitable physical principles, and a capacitive, inductive, or optical measurement principle may be used.

Coupling plate 60 has first and second coupling points 61 and 62 at which the coupling plate is connected to control element 70. Coupling points 61, 62 are designed as openings in which first and second coupling protrusions 71 and 72 of control element 70 can respectively engage.

First coupling point 61 is situated between entrainment slots 63 for actuation bars 12 of first and third force sensors 1 and 3. As such, control element 70 acts on first and third force sensors 1 and 3 via first coupling point 61.

Second coupling point 62 is situated near the entrainment slot 63 for actuation bar 12 of second force sensor 2. As such, control element 70 acts almost exclusively on second force sensor 2 via second coupling point 62.

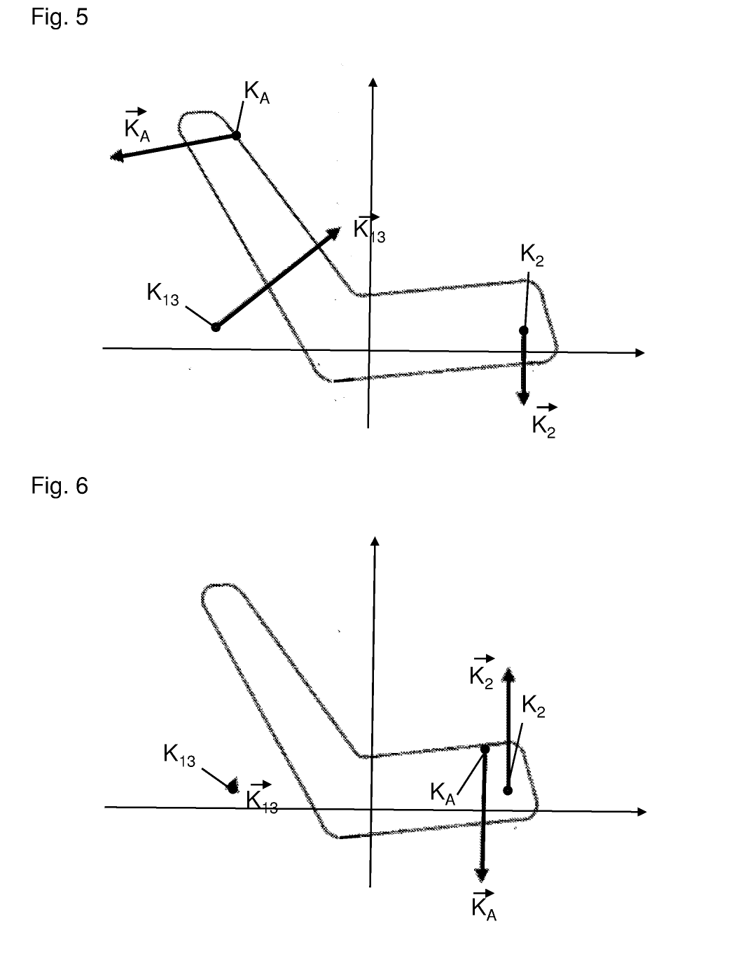

FIGS. 3, 4, 5, and 6 illustrate schematic top views depicting first, second, third, and fourth examples, respectively, of possible actuations of control element 70. Coupling points 61, 62 are functionally illustrated as force transmission points K₁₃ and K₂ in FIGS. 3, 4, 5, and 6.

The two adjacently situated first and third force sensors 1 and 3, due to their orientation on support plate 40, detect mutually perpendicular force directions. The signals of first and third force sensors 1 and 3 which result during an application of force on control element 70 may thus be combined into a sensor signal, as indicated in FIGS. 3, 4, 5, and 6, that describes a magnitude and a direction within a plane. This information is denoted as force vector \vec{K₁₃} in FIGS. 3, 4, 5, and 6, and describes the reaction forces of first and third force sensors 1 and 3. In contrast, second force sensor 2 detects the force in a single specified force direction, and as information supplies the magnitude of the force acting specifically in this direction. This information is denoted as force vector \vec{K₂} in FIGS. 3, 4, 5, and 6, and describes the reaction forces of second force sensors 2.

The actuation of control element 70 takes place due to a force effect on contour 80 of control element 70 at a selectable force application point K_{A}. The actuation force and actuation direction may be described by a vector that may be referred to as force application vector \vec{K_{A}}. Since under the force effect an equilibrium state is immediately established when control element 70 is actuated, the actuation force that is applied is compensated for by the reaction forces of force sensors 1, 2, 3. This means that the force vectors \vec{K₁₃}, \vec{K₂}, and \vec{K_{A}} add up to form a null vector, as schematically illustrated in FIG. 3.

Conversely, this means that the magnitude and direction of the force application vector \vec{K_{A}} of the actuation force that is applied to control element 70 may be determined from the force vectors \vec{K₁₃} and \vec{K₂} determined by force sensors 1, 2, 3.

For determining the selected actuation function, it is now necessary to know the application point K_{A} of the actuation force \vec{K_{A}} at contour 80 of control element 70. This information may be computed from the condition that in the equilibrium state mentioned above, not only a force equilibrium, but also a torque equilibrium must be established at control element 70.

Depending on the shape of control element 70, the secondary condition that the applied actuation force \vec{K_{A}} acts on the surface of control element contour 80 is often sufficient to unambiguously determine the force application point K_{A} based on the force vectors \vec{K₁₃} and \vec{K₂}. It is optionally possible to associate an actuation function, which is to be carried out, with the force directions and force magnitudes detected by sensor, in a respective table.

FIG. 3 shows the forward displacement of the head restraint of the vehicle seat as a first example of the selected actuation function. The subsequent figures, strictly by way of example, depict the forces that occur for triggering the control functions “rear seat cushion lower” (FIG. 4), “head restraint backward” (FIG. 5), and “seat cushion forward” (FIG. 6).

### LIST OF REFERENCE NUMERALS

1, 2, 3 force sensors
10 sensor housing
11 actuation element
12 actuation bar
40 support plate
50 screws
60 coupling plate
61 first coupling point
62 second coupling point
63 entrainment slot, recess
70 control element
71 first coupling protrusion
72 second coupling protrusion
73 protrusion
80 contour (line)
81 (inclined) section
82 (horizontally oriented) section
83 head restraint section
\vec{K₁₃} and \vec{K₂} force vectors (sensor reaction forces)
\vec{K_{A}} force application vector
K_{A} force application point
K₁₃, K₂ force transmission points
K_{H}, K_{R}, K_{V}, K_{Z} actuation functions of the head restraint
L_{V}, L_{Z} actuation functions of the seat back
S_{V}, S_{Z}, S_{HH}, S_{HR}, S_{VH}, S_{VR} actuation functions of the seat cushion

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. An operating device for an actuator-adjustable vehicle seat, comprising:
a control element having an outer contour which simulates an outline shape of a vehicle seat;
three force sensors including a first force sensor, a second force sensor, and a third force sensor, each force sensor can measure force in only one direction, the first and third force sensors are situated in parallel with one another, and the second force sensor is situated perpendicularly with respect to the first and third force sensors; and
wherein the force sensors are configured to detect pressing actuations directed to various locations on the outer contour of the control element for triggering different adjustment movements of the vehicle seat and an actuation position and an actuation direction of a pressing actuation of a finger on the outer contour of the control element for triggering an adjustment movement of the vehicle seat is detectable from reaction forces of the force sensors.

2. The operating device of claim 1 further comprising:
a coupling plate connected to the control element; and
wherein transmission of force of the pressing actuations directed to various locations on the outer contour of the control element to the force sensors occurs via the coupling plate.

3. The operating device of claim 1 wherein:
the first force sensor and the third force sensor each measure vertical forces; and
the second force sensor measures horizontal forces.

4. The operating device of claim 1 wherein:
the control element forms a first section and a second section, the first section of the control element has an outer contour which simulates an outline shape of a head restraint and a seat back of the vehicle seat and is for adjusting the head restraint and the seat back of the vehicle seat, and the second section of the control element has an outer contour which simulates an outline shape of a seat cushion of the vehicle seat and is for adjusting the seat cushion of the vehicle seat.

5. The operating device of claim 1 further comprising:
an electronics system controller to detect the actuation position and the actuation direction of the finger on the outer contour of the control element from the reaction forces of the force sensors and to use the detected actuation position and actuation direction in controlling actuators to adjust the vehicle seat.

6. The operating device of claim 1 wherein:
the force sensors have an identical design.

7. The operating device of claim 1 further comprising:
a coupling plate connected to the control element, the coupling plate having entrainment slots;
a support plate; and
wherein each force sensor has a sensor housing fastened to the support plate, each force sensor further having a strip-shaped actuation element situated within the sensor housing, each actuation element having an actuation bar, the actuation bars of the sensors are respectively inserted into the entrainment slots of the coupling plate to mechanically connect the actuation elements of the force sensors to the coupling plate such that transmission of force of the pressing actuations directed to various locations on the outer contour of the control element to the force sensors occurs via the coupling plate and the actuation elements of the force sensors.

8. The operating device of claim 7 wherein:
the coupling plate has a first coupling point and a second coupling point at which the coupling plate is connected to the control element;
the first coupling point is situated between the entrainment slots for the actuation bars of the first and third force sensors, which are situated in parallel with one another, whereby the control element acts on the first and third force sensors via the first coupling point; and
the second coupling point is situated near the entrainment slot for the actuation bar of the second force sensor, which is situated perpendicularly with respect to the first and third force sensors, whereby the control element acts on the second force sensor via the second coupling point.
